(19) United States
(12) Patent Application Publication
(10) Pub. No.: US 2017/0359975 A1
(43) Pub. Date: Dec. 21, 2017

(54) TRAVELLING IRRIGATION SPRINKLERS AND ASSEMBLIES

(71) Applicant: Stellenbosch University, Stellenbosch, WC (ZA)

(72) Inventor: Hanno Carl Rudolf REUTER, Stellenbosch (ZA)

(21) Appl. No.: 15/527,680

(22) PCT Filed: Nov. 17, 2015
(86) PCT No.: PCT/IB2015/058878

§ 371 Date: May 17, 2017

(30) Foreign Application Priority Data
Nov. 18, 2014 (ZA) 2014/08443

(51) Int. Cl. A01G 25/09; B05B 1/20; G05B 15/02

(52) U.S. Cl. CPC A01G 25/092; B05B 1/20; G05B 15/02

(57) ABSTRACT

A travelling agricultural irrigation installation is provided having multiple generally horizontal irrigation sprinklers each being a length of pipe closed at each end and having multiple outlet orifice sets along the length thereof. Each orifice is in the form of a hole through the pipe wall having an orifice diameter selected to provide, in use, a jet of water that breaks up into droplets. Each orifice set comprises multiple orifices having axes extending in different angular directions relative to the pipe axis to provide a generally rectangular spray pattern. The length of each sprinkler pipe or the number of orifice sets is dependent on the speed at which the sprinkler is to move over the ground. Typically the installation is a centre pivot installation; the sprinkler pipes are all connected to a common radial main supply pipe; and the water delivery increases with increased distance from the centre pivot.

### CROSS-REFERENCE(S) TO RELATED APPLICATIONS

This application claims priority from South African provisional patent application number 2014/08443 filed on 18 Nov. 2014, which is incorporated by reference herein.

### FIELD OF THE INVENTION

This invention relates to travelling agricultural irrigation sprinklers and assemblies thereof of the type in which a main supply pipe is supported in an elevated position by mobile frames or reasonably large diameter wheels, and multiple sprinklers are supplied with irrigation water by the main supply pipe with the sprinklers often being carried at or towards lower ends of drop tubes (often simply referred to as drops).

More particularly, but not exclusively, the invention relates to irrigation assemblies of the centre pivot type in which a radially extending main supply pipe and its support structure is pivotally attached to a central tower and is supported at radially spaced positions by mobile tower frames, typically A-frames, so as to be movable over a circular agricultural area.

### BACKGROUND TO THE INVENTION

Centre pivot irrigation systems generally consist of a radial main supply pipe supported by a central tower about which the entire system rotates and by radially spaced mobile towers, typically of an A-framed configuration. Steel or aluminium trusses and rods typically extend between these spaced supports to carry the weight of the radial main supply pipe and water in it. The mobile towers are fitted with wheels that are driven by electric or hydraulic motors geared to provide a suitably high torque for moving the irrigation system. The entire operation of the centre pivot irrigation system is controlled by a computer aided management system which is typically located at the central tower.

Outlets to which sprinklers are attached are provided along the length of the radial main supply pipe and the sprinklers can be directly attached to the radial main supply pipe, or, in a more efficient system, are connected to the radial main supply pipe by drop tubes that position the sprinklers closer to the ground to decrease wind and evaporative losses. The water pressure within the system is relatively high in order to achieve satisfactory distribution of water throughout the system and a pressure regulator is provided upstream of each sprinkler to regulate the pressure to a predetermined operating point that is dependent on the position of the sprinkler in the system and the performance characteristics of the associated sprinkler.

In this way a substantially even spread of water can be achieved irrespective of the fact that the sprinklers closer to the central tower move more slowly relative to the ground than those further away from the central tower although an appreciable amount of overwatering is usually necessary in some areas. The passage of water through the sprinklers constitutes a second pressure drop. The sprinklers currently used, require a high water pressure head to spread the water over the required area and the fine droplets that are formed by the sprinklers may result in significant water losses due to drift and evaporation, especially under windy conditions. Currently, many so-called low pressure sprinklers operate at pressures of about 100 kPa although many other systems still operate at much higher pressures even up to about 275 kPa. As an example, it was determined that one arrangement operated on 140 kPa and that 40 kPa was dissipated across the pressure regulator and 100 kPa across the sprinkler

Energizing pumps to achieve these relatively high pressures consume a certain amount of energy most of which is dissipated when the pressure is released either by the pressure regulator or by the sprinkler itself. That energy costs money.

It is considered that there is room for an improvement in this regard whilst maintaining satisfactory watering conditions and a generally even spread of irrigation water over the irrigated land.

The preceding discussion of the background to the invention is intended only to facilitate an understanding of the present invention. It should be appreciated that the discussion is not an acknowledgment or admission that any of the material referred to was part of the common general knowledge in the art as at the priority date of the application.

### SUMMARY OF THE INVENTION

In accordance with one aspect of this invention there is provided a travelling agricultural irrigation installation comprising multiple generally horizontal irrigation sprinklers each of which comprises a length of pipe closed at each end and having a longitudinal axis; a water inlet to the interior of the sprinkler pipe; and multiple outlet orifice sets along the length thereof whereof each orifice is in the form of a hole through the pipe wall having an orifice diameter selected to provide, in use, a jet of water that breaks up into droplets, and wherein each orifice set comprises multiple orifices having axes extending in different angular directions relative to the pipe axis to provide a generally rectangular spray pattern and wherein the length of each sprinkler pipe or the number of orifice sets or both is or are dependent on the speed at which the sprinkler is to move over the ground in use.

It will be understood that the water flow rate and manufacturing costs are significant considerations to take into account when designing an installation as defined above.

Further features of the invention provide for the travelling agricultural irrigation installation to be a centre pivot irrigation installation in which instance the sprinkler pipes are all connected to a common radial main supply pipe and the length of each of the sprinkler pipes or number of orifice sets increases with increased distance from the centre pivot such that substantially even distribution of water over the entire circular irrigated area is achieved; for the sprinkler pipes to extend in a generally tangential direction relative to the circular path of movement of the relevant sprinkler pipe; for there to be limited overlap between adjacent rectangular spray patterns so that annular bands of successive radially spaced irrigation sprinklers associated with the radial main supply pipe overlap to a limited extent; and for each of the sprinkler pipes to be carried in inverted Tee fashion at the lower end of a drop tube that is in turn connected to the radial main supply pipe.

Still further features of the invention provide for the travelling agricultural irrigation installation to be designed to operate on a water pressure of from 0.2 m of water to 5.0 m of water, preferably from 0.5 m of water to 1.0 m of water and most preferably about 0.75 m of water; for the diameter of the orifices to be from 0.75 mm to 2.00 mm with a preferred diameter being about 1.0 to 1.25 mm; for each orifice set to comprise angularly spaced orifices extending around approximately a semi-circular path relative to the sprinkler pipe with an optional axial offset of selected orifices to accommodate a required number of orifices in an orifice set; for each orifice set to comprise one or more rows of orifices; for the orifice sets to be spaced apart along the length of a sprinkler pipe by distances from 0.2 m and more preferably between 0.5 m and 0.8 m; and for the height of the sprinkler pipes above the ground to be from 1.0 to 4.0 metres with a preferred height being about 2.5 or 3.0 m.

The invention also provides individual sprinkler pipes that are designed for inclusion in a travelling agricultural irrigation installation as defined above.

The sprinkler of the invention is thus a low pressure water sprinkler that is designed to provide similar irrigation performance to conventional higher pressure irrigation systems currently in use both with regard to composite average application rate, sprinkler kinetic energy and composite specific power. The system of the invention, however, requires considerably less upstream pressure compared to conventional sprinklers that can be as low as 5% of the pressures currently used, thereby reducing power consumption significantly. Furthermore, more uniform water distribution and uniform larger drop sizes can be attained which decrease water consumption due to reduced local over-irrigation and lower wind drift losses. Due to the low pressures, the velocity of the water is much lower than the terminal velocity of drops falling through air, which reduces the kinetic energy of the water impacting on the ground when compared to rain drops.

The simplicity of the system allows for ease of manufacture which is a significant advantage compared to conventional sprinklers that are generally mass produced in high-tech facilities at relatively high cost.

### BRIEF DESCRIPTION OF THE DRAWINGS

The invention will now be described, by way of example only, with reference to the accompanying representations in which:

FIG. 1 is a schematic elevation of a centre pivot irrigation system to which the invention has been applied;

FIG. 2 is a plan view thereof showing the way in which three adjacent radially spaced irrigation sprinkler pipes operate in accordance with the invention;

FIG. 3 is an elevation of a single sprinkler pipe according to the invention;

FIG. 4 is an enlarged cross-section taken through one orifice set along the length of the sprinkler pipe such as at a position indicated by line IV to IV in FIG. 3;

FIG. 5 is a graphic illustration of the spray pattern of one side of an irrigation sprinkler pipe as illustrated in FIGS. 3 and 4; and,

FIG. 6 is a graphic illustration showing an example of the effect of pipe diameter on mass of the sprinkler pipe and the head loss over a 1 m length of the pipe with a flow velocity of 1 m/s.

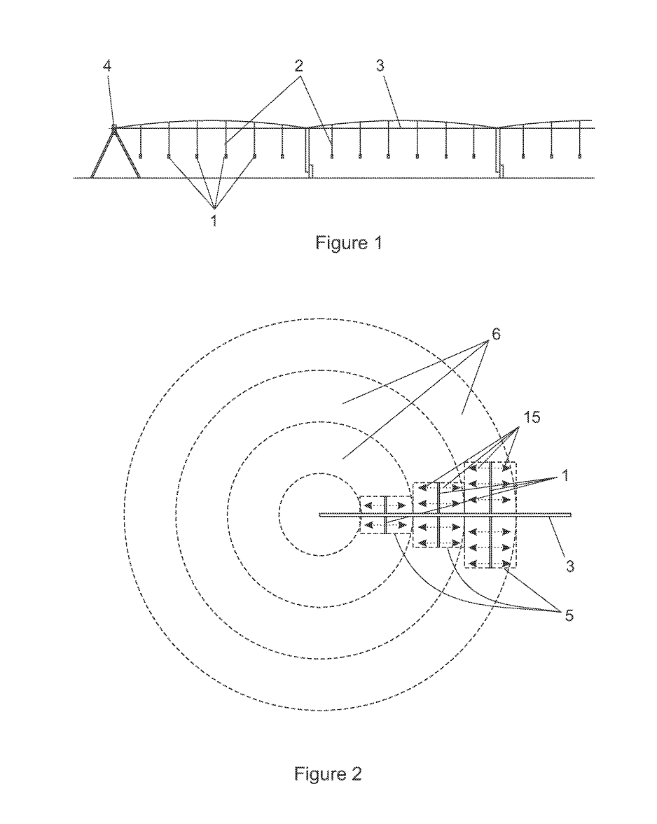

### DETAILED DESCRIPTION WITH REFERENCE TO THE DRAWINGS

In the embodiment of the invention illustrated in the drawings the invention is applied to a centre pivot irrigation system in which horizontal sprinkler pipes (1) are attached to the lower ends of drops tubes (2) that are all connected to a common radial main supply pipe (3). As will be quite apparent from a reference to FIG. 2, the length of each of the sprinkler pipes increases with increasing distance from the centre pivot (4) such that essentially even distribution of water over the entire circular irrigated area is achieved. The sprinkler pipes extend in a generally tangential direction relative to the circular path of movement of the relevant sprinkler pipe in plan view.

It will be understood that an arrangement of sprinkler pipes of this nature provides for generally rectangular patterns of spray area as indicated by numeral (5). This being so, there may be only a small overlap between adjacent rectangular spray patterns so that the resultant annular bands (6) of successive radially spaced irrigation sprinklers associated with the radial main supply pipe overlap to a limited extent such as by about 10 cm. This feature drastically reduces the problem of overwatering consequent on the overlap of what are generally circular spray patterns. The sprinkler pipes (1) are carried in inverted Tee fashion at the lower end of its associated drop tube that is in turn connected to the main supply pipe (3).

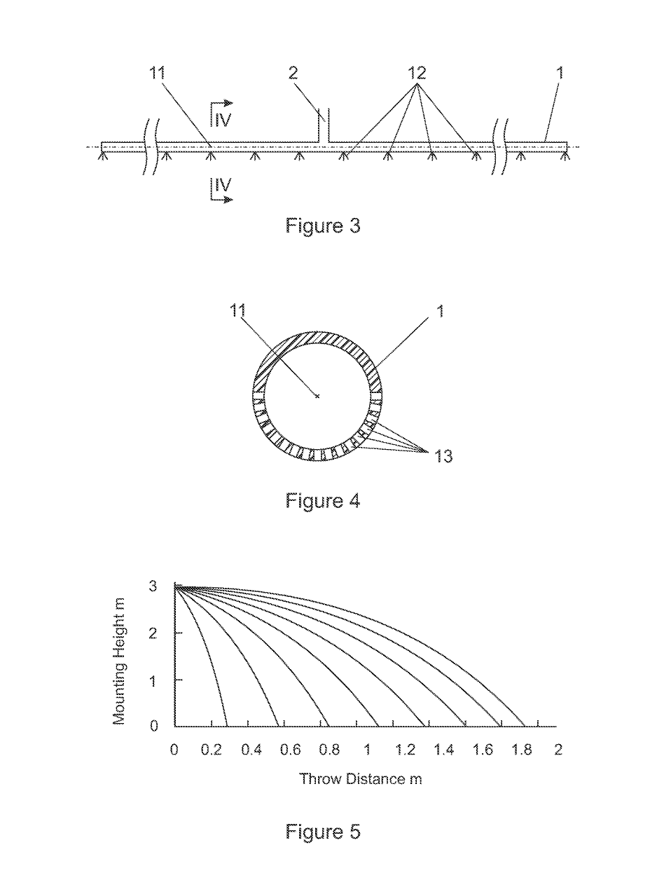

Each of the sprinkler pipes is closed at each end and has a longitudinal axis that is indicated by numeral (11) in FIG. 3. The water inlet to the interior of the sprinkler pipe that attaches to the drop tube is located centrally along the length of the sprinkler pipe as indicated by numeral (2).

Each sprinkler pipe has multiple outlet orifice sets (12) (see FIG. 3) spaced apart along the length thereof whereof each individual orifice (13) (see FIG. 4) is in the form of a hole through the pipe wall having an orifice diameter selected to provide, in use, a jet of water that breaks up into droplets of an appropriate diameter. Each orifice set comprises multiple orifices having axes extending in different angular directions relative to the sprinkler pipe axis (11) with the axes of the orifices being radial with respect to the sprinkler pipe axis. The length of each sprinkler pipe or the number of orifice sets on each sprinkler pipe or both is calculated according to the flow rate and speed at which the sprinkler pipe is to move over the ground in use and therefore according to the radial distance from the centre pivot.

Turning now to more specific details of the sprinkler pipes and orifices, the diameter of the sprinkler pipes can be calculated using normal fluid flow techniques in order to achieve a suitable pressure drop within the sprinkler pipes and, indeed the whole system. When it comes to selecting a sprinkler pipe diameter there are two opposing parameters that need to be considered; firstly, the frictional losses in the pipe, and secondly the weight of the water in the pipe that needs to be supported by the common radial main supply pipe (3) and supporting structure. The frictional loss in the pipe is inversely proportional to the diameter of the pipe which means that for minimum frictional losses in the sprinkler pipe the diameter should be maximized.

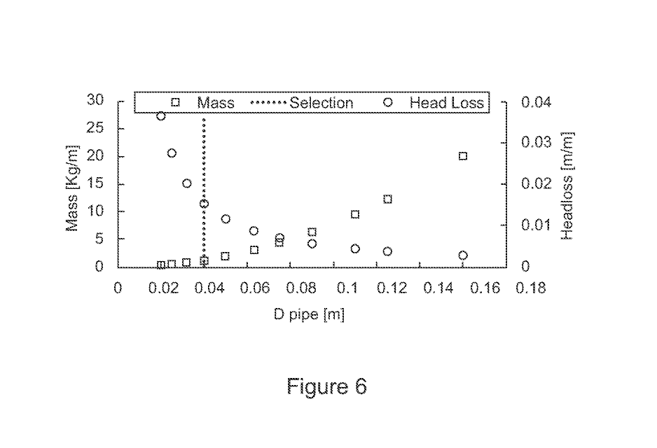

However, the mass of the water in the pipe is proportional to the diameter of the sprinkler pipe and therefore a larger pipe diameter means more mass to be supported by the common radial main supply pipe (3) and supporting structure. FIG. 6 illustrates graphically an example of results of calculations that were made within a range to illustrate the effect of the pipe diameter on the mass of water in the pipe and the head loses in the pipe for a 1 m segment of smooth PVC pipe with an average flow velocity of 1 m/s. It was decided that a kilogram of water per meter of pipe is acceptable and that corresponds to a 40 mm pipe diameter.

FIG. 4 shows a cross-section through one form of orifice set in a sprinkler pipe as described above. The orifice set, in this instance, consists of 17 holes evenly angularly spaced in a semicircle being the lower half of the circumference of the sprinkler pipe. The orifice diameters were calculated to be approximately one half of the size of the desired droplet size, in this instance the orifice diameter is 1.1 mm for a target 2 mm diameter droplet size. The sprinkler pipe was a 40 mm class 6 U-PVC pipe. The orifices are angularly spaced by 11.25 degrees as shown in FIG. 4.

It should be noted that if the diameter of the orifices and the angular spacing of the orifices tends to weaken the sprinkler pipe wall to an undesirable extent, the individual orifices of a set could be axial offset to some extent to provide a greater amount of wall between the orifices of a set and thereby achieve the required strength of the pipe wall.

Sprinkler pipes located towards the inner end of the common radial main supply pipe may have only one or two orifice sets spaced apart along the length of the sprinkler pipe by a distance of say 0.7 m with the number of orifice sets increasing progressively with increasing distance from the centre pivot. These distances are variable according to surrounding circumstances including the selection of pipe for the sprinkler pipes and the conditions of the soil.

The height of the sprinkler pipes above the ground is, in this embodiment of the invention, about 3.0 m.

The projected spray pattern on one side of the sprinkler pipe is shown in FIG. 5 which indicates that the maximum throw of the orifice set will be about 1.9 m thus giving an overall width of the rectangular spray pattern of 3.8 m.

A more uniform water distribution is thus achieved with larger, more uniform drops being produced with an expected reduction in water losses and therefore water consumption. Water from a dam or the ground is pumped to the central tower via strainers and then via the radial main supply pipe (3) to the sprinkler pipes. The lateral sprinkler pipes distribute the water in the tangential direction perpendicular to the radial main supply pipe before the water flows through the orifices in a generally radial direction, as shown in FIG. 2 and as indicated by numeral (15). A reduction in pumping power is achieved because pressure energy conversion to kinetic energy is very much diminished in order to achieve the required water distribution. Each orifice creates a water jet which is directed by the orifice to a location where the water is required. The area to be irrigated increases linearly with radius, and therefore the water flow rate must also increase linearly with radius from the centre pivot. To meet the required application rate limits, the sprinkler tubes become longer with an increase in radius and the number of orifice sets also increases linearly.

It will be understood that design variations of sprinkler pipes and irrigation installations according to the invention will vary widely and there are many different installations that are possible within the scope of the invention. The primary steps to be taken when implementing the invention are that the initial selection of parameters should include that of operating pressure head; mounting height of the sprinkler pipes; the sprinkler pipe diameter; the droplet size desired and therefore the orifice size; the spacing between individual orifices and between orifice sets; and the targeted average application rate of water.

Once these selections have been made or otherwise determined the maximum number of orifices in each set needs to be calculated it being accepted that there may be more than one row of orifices in a set; part of which is selecting the offset angle between the two most remote orifices in a row or set. The maximum impact velocity and impact kinetic energy of the individual drops as well as the maximum throw distance and flow rate of each orifice it can be calculated. Also, the orifices could be located on an upper semi-circular half of the sprinkler pipe provided that some provision is made that the holes be drilled in an oblique line to prevent trajectory interference.

The sprinkler pipe spacing along the radial main supply pipe needs to be determined as well as the length of each sprinkler pipe at selected outlets as well as the number of orifice sets required on each sprinkler pipe. The degree of overlap of spray patterns from radially adjacent sprinkler pipes needs to be determined which will determine the degree of overwatering. Of course, if the invention is to be applied to an existing centre pivot arrangement, the existing outlets may be advantageously used and should be taken into consideration. Finally, the pressure drop across each sprinkler pipe at each outlet can be determined followed by an evaluation of the design concept with regard to required performance criteria.

The succession of actions outlined above can then be repeated, as may be required, in order to achieve a suitable application to what may be existing centre pivot equipment and to achieve the required extent of irrigation.

The invention therefore provides a highly flexible yet simple and effective travelling agricultural irrigation assembly and sprinklers for inclusion therein.

Throughout the specification and claims unless the contents requires otherwise the word ‘comprise’ or variations such as ‘comprises’ or ‘comprising’ will be understood to imply the inclusion of a stated integer or group of integers but not the exclusion of any other integer or group of integers.

1. A travelling agricultural irrigation installation comprising multiple generally horizontal irrigation sprinklers each of which comprises a length of sprinkler pipe closed at each end and having a longitudinal axis; a water inlet to the interior of the sprinkler pipe; and multiple outlet orifice sets along the length of the sprinkler pipe, wherein each orifice is in the form of a hole through the sprinkler pipe wall having an orifice diameter selected to provide, in use, a jet of water that breaks up into droplets, and wherein each orifice set comprises multiple orifices having axes extending in different angular directions relative to the sprinkler pipe axis to provide a generally rectangular spray pattern and wherein the length of each sprinkler pipe or the number of orifice sets or both is or are dependent on the speed at which the sprinkler is to move over the ground in use.

2. A travelling agricultural irrigation installation as claimed in claim 1 in which the travelling agricultural irrigation installation is a centre pivot irrigation installation and the sprinkler pipes are all connected to a common radial main supply pipe and the length of each of the sprinkler pipes or number of orifice sets increases with increased distance from the centre pivot such that substantially even distribution of water over an entire circular irrigated area is achieved

3. A travelling agricultural irrigation installation as claimed in claim 2 in which the sprinkler pipes extend in a generally tangential direction relative to the circular path of movement of the relevant sprinkler pipe.

4. A travelling agricultural irrigation installation as claimed in claim 2 in which there is limited overlap between adjacent rectangular spray patterns so that annular bands of successive radially spaced irrigation sprinklers associated with the radial main supply pipe overlap to a limited extent.

5. A travelling agricultural irrigation installation as claimed in claim 1 in which each of the sprinkler pipes is carried in inverted Tee fashion at a lower end of a drop tube that is in turn connected to the main supply pipe.

6. A travelling agricultural irrigation installation as claimed in claim 1 in which the installation is designed to operate on a water pressure of from 0.2 m of water to 5.0 m of water.

7. A travelling agricultural irrigation installation as claimed in claim 1 in which the installation is designed to operate on a water pressure of from 0.5 m of water to 1.0 m of water.

8. A travelling agricultural irrigation installation as claimed in claim 1 in which the diameter of the orifices is from 0.75 mm to 2.00 mm.

9. A travelling agricultural irrigation installation as claimed in claim 1 in which the diameter of the orifices is from 1.0 to 1.25 mm.

10. A travelling agricultural irrigation installation as claimed in claim 1 in which each orifice set comprises angularly spaced orifices extending around approximately a semi-circular path relative to the sprinkler pipe with an optional axial offset of selected orifices to accommodate a required number of orifices in an orifice set.

11. A travelling agricultural irrigation installation as claimed in claim 1 in which each orifice set comprises one or more rows of orifices with the orifice sets being spaced apart along the length of a sprinkler pipe by distances at least 0.2 m.

12. A travelling agricultural irrigation installation as claimed in claim 11 in which the orifice sets are spaced apart along the length of a sprinkler pipe by distances of between 0.5 m and 0.8 m.

13. A travelling agricultural irrigation installation as claimed in claim 1 in which the height of the sprinkler pipes above the ground is from 1.0 to 4.0 metres.

14. A travelling agricultural irrigation installation as claimed in claim 13 in which the height of the sprinkler pipes above the ground is from 2.5 to 3.0 m.

15. A sprinkler pipe for a travelling agricultural irrigation installation as claimed in comprising a length of pipe closed at each end and having a longitudinal axis; a water inlet to the interior of the sprinkler pipe; and multiple outlet orifice sets along the length of the sprinkler pipe, wherein each orifice is in the form of a hole through the sprinkler pipe wall having an orifice diameter selected to provide, in use, a jet of water that breaks up into droplets, and wherein each orifice set comprises multiple orifices having axes extending in different angular directions relative to the sprinkler pipe axis to provide a generally rectangular spray pattern and wherein the length of each sprinkler pipe or the number of orifice sets or both is or are dependent on the speed at which the sprinkler pipe is to move over the ground in use.
